(19) United States
(12) Patent Application Publication
(10) Pub. No.: US 2014/0188630 A1
(43) Pub. Date: Jul. 3, 2014

(54) CONFIGURABLE CLEARING PRICE LOGIC FOR AD EXCHANGES

(71) Applicant: MICROSOFT CORPORATION, Redmond, WA (US)

(72) Inventors: ANDREW CHRISTOPHER BALAZS, Seattle, WA (US); ERIK JON HANSON, Woodinville, WA (US)

(73) Assignee: MICROSOFT CORPORATION, Redmond, WA (US)

(21) Appl. No.: 13/732,011

(22) Filed: Dec. 31, 2012

(51) Int. Cl. G06Q 30/02

(52) U.S. Cl. CPC G06Q 30/0275
USPC 705/14.71

(57) ABSTRACT

Systems, methods, and computer-readable storage media are provided for altering clearing price logic at auction time. Configurable parameters included in the clearing price logic make the logic configurable at run time based upon one or more of an ad size, the identity of the pages on which ads are presented, the content of the pages on which ads are presented, a targeting segment of which a user or browser ID is a member, or any combination thereof. This enables experimentation in the exchange and optimization of the logic without requiring alterations in the code and ensures that the price paid is at least equivalent to the minimum bid that would have been needed to win the auction.

### BACKGROUND

An online ad exchange is a technology platform that facilitates the bidded buying and selling of online media advertising inventory from multiple ad networks. In an online ad exchange, the clearing price logic of the exchange is the set of rules and conditions configured by the content publishers that determines who wins an ad auction and how much the winning demand source will be charged for a particular impression (i.e., the clearing price). Generally, the logic utilized is a static set of rules that can only be changed or adjusted by changing the code. This makes experimentation, adjustment and optimization of the clearing price logic a very tedious and time consuming process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for altering clearing price logic at auction time. Configurable parameters included in the clearing price logic make the logic configurable at run time based upon one or more of ad sizes, the identity of the pages on which ads are presented, the content of the pages on which ads are presented, targeting segments of which the user or browser ID is a member, or any combination thereof. This enables experimentation in the exchange and optimization of the logic without requiring alterations in the code and ensures that the price paid is at least equivalent to the minimum bid that would have been needed to win the auction. In accordance with embodiments hereof, bids that are below the floor price are not included when computing the clearing price for the winning bid.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for determining clearing prices in ad exchanges utilizing configurable parameters, in accordance with an embodiment of the present invention;

FIG. 4 is a flow diagram showing another exemplary method for determining clearing prices in ad exchanges utilizing configurable parameters, in accordance with an embodiment of the present invention;

FIG. 5 is a flow diagram showing yet another exemplary method for determining clearing prices in ad exchanges utilizing configurable parameters, in accordance with an embodiment of the present invention; and

FIG. 6 is a flow diagram showing still another exemplary method for determining clearing prices in ad exchanges utilizing configurable parameters, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for altering clearing price logic at auction time. Configurable parameters included in the clearing price logic make the logic configurable at run time based upon one or more of ad sizes, the identity of the pages on which ads are presented, the content of the pages on which ads are presented, targeting segments of which the user (i.e., the consumer of the page content) or browser ID is a member, or any combination thereof. This enables experimentation in the exchange and optimization of the logic without requiring alterations in the code and ensures that the price paid is at least equivalent to the minimum bid that would have been needed to win the auction. In accordance with embodiments hereof, bids that are below the floor price are not included when computing the clearing price for the winning bid.

Accordingly, one embodiment of the present invention is directed to one or more computer-readable storage media storing computer-useable instructions that, when used by one or more computing devices, cause the one or more computing devices to perform a method for determining clearing prices in ad exchanges. The method includes receiving a plurality of bids for an ad impression and determining that there is a winning bid of the plurality of received bids by applying, at auction time, at least one first configurable parameter to at least a portion of the received bids. The method further includes determining a clearing price for the winning bid.

In another embodiment, the present invention is directed to a method being performed by one or more computing devices including at least one processor, the method for determining clearing prices in ad exchanges. The method includes receiving a plurality of bids for an ad impression and determining that there is a winning bid of the plurality of received bids by applying at least one first configurable parameter to at least a portion of the received bids. The method further includes applying at least one second configurable parameter to determine a clearing price for the winning bid.

In yet another embodiment, the present invention is directed to one or more computer-readable storage media storing computer-useable instructions that, when used by one or more computing devices, cause the one or more computing devices to perform a method for determining clearing prices in ad exchanges. The method includes receiving a plurality of bids for an ad impression and determining that there is a winning bid of the plurality of received bids by applying at least one configurable parameter to at least a portion of the received bids to determine a threshold value for selling the ad impression, and determining that the threshold value is met by the winning bid. Each first configurable parameter is equivalent to a predetermined spread between a highest qualified biased bid and a second-highest qualified biased bid for winning the ad impression, a multiple of a highest qualified biased bid submitted by an internal demand source, or a multiple of a highest qualified biased non-winning bid. The method further includes applying at least one second configurable parameter to determine a clearing price for the winning bid. Each second configurable parameter is utilized to determine whether a highest qualified non-winning biased bid is used in determining the clearing price for the winning bid or to determine whether a highest qualified non-winning raw bid is used in determining the clearing price for the winning bid.

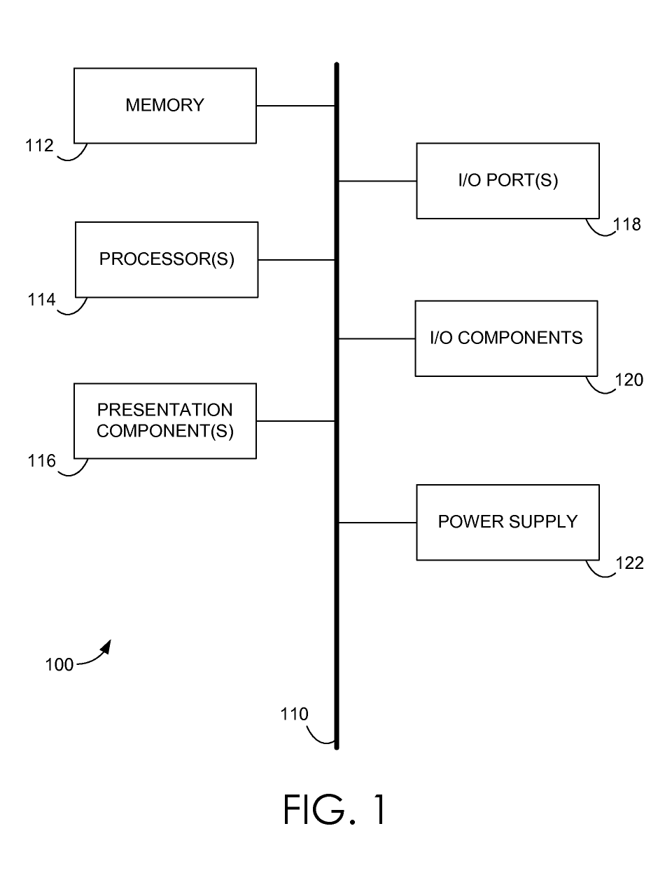

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like. Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

As previously mentioned, embodiments of the present invention are generally directed to systems, methods, and computer-readable storage media for configuring the logic by which it is determined whether a bid for an ad impression is a winning bid and what the clearing price for the winning bid is. By having configurable parameters in the clearing price logic, values associated with these parameters can be changed at run time thus altering/optimizing the clearing price without a concurrent change in the code.

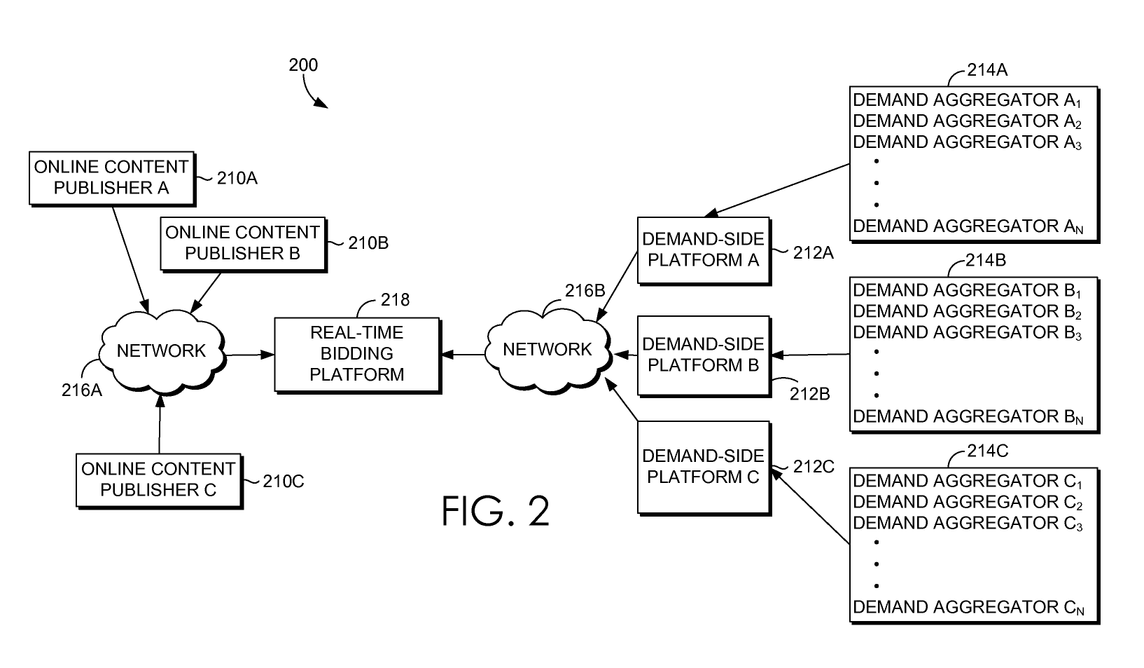

Referring now to FIG. 2, a block diagram is provided illustrating an exemplary computing system 200 in which embodiments of the present invention may be employed. Generally, the computing system 200 illustrates an environment in which, clearing price logic may be altered at run time utilizing configurable parameters. Among other components not shown, the computing system 200 generally includes a plurality of online content publishers (210A, 210B, 210C), a plurality of demand-side platforms (212A, 212B, 212C) a plurality of demand aggregators (214A, 214B, 214C), and a real-time bidding platform 218, all in communication with one another via networks 216A, 216B. The networks 216A, 216B may include, without limitation, one or more local area networks (LANs) and/or wide area networks (WANs). Such networking environments are commonplace in offices, enterprise-wide computer networks, intranets and the Internet. Accordingly, the networks 216A, 216B are not further described herein.

It should be understood that any number of online content publishers (210A, 210B, 210C), demand-side platforms (212A, 212B, 212C) and/or demand aggregators (214A, 214B, 214C) may be employed in the computing system 200 within the scope of embodiments of the present invention. Each may comprise a single device/interface or multiple devices/interfaces cooperating in a distributed environment. For instance, demand-side platform A 212A may comprise multiple devices and/or modules arranged in a distributed environment that collectively provide the functionality of the demand-side platform A 212A described herein. Additionally, other components/modules not shown also may be included within the computing system 200.

In some embodiments, one or more of the illustrated components/modules may be implemented as stand-alone applications. In other embodiments, one or more of the illustrated components/modules may be implemented as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be associated with any number of online content publishers, demand-side platforms, or demand aggregators. By way of example only, demand-side platform A 212A might be a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Each online content publisher (210A, 210B, 210C) may be associated with any type of computing device, such as the computing device 100 described with reference to FIG. 1, for example. Generally, each online content publisher (210A, 210B, 210C) has one or more web pages of content configured for presentation online, at least a portion of the web pages having available ad space. Each online content publisher (210A, 210B, 210C) is configured to submit its available ad inventory (for instance, via the network 216A) to the real-time bidding platform 218. Further, in embodiments, each online content publisher (210A, 210B, 210C) is configured to provide rules or logic to the real-time bidding platform 218 (again, e.g., via the network 216A) that may be used to determine the demand sources permitted to participate in each auction. Still further, in embodiments, each online content publisher (210A, 210B, 210C) is configured to submit values for configurable parameters in the associated clearing price logic to the real-time bidding platform 218. In embodiments, each online content publisher (210A, 210B, 210C) further is configured to submit attributes to the real-time bidding platform 218 that the real-time bidding platform is able to utilize to determine values for configurable parameters. For instance, in embodiments, an online content publisher (210A, 210B, 210C) may submit a look-up table of parameter values to the real-time bidding platform 218 along with the available ad inventory and the like, the real-time bidding platform 218 being configured to look-up parameter values in the table without any corresponding change in the code, as more fully described below.

Each demand-side platform (212A, 212B, 212C) may be associated with any type of computing device, such as the computing device 100 described with reference to FIG. 1, for example. Generally, each demand-side platform (212A, 212B, 212C) is configured to accept and/or determine bids for available ad inventory utilizing information provided from one or more demand aggregators (e.g., demand-side platform A 212A is configured to accept and/or determine bids based upon information provided from each of demand aggregators A₁, A₂, A₃ . . . A_{N} (214A)). In this regard, the demand-side platforms (212A, 212B, 212C) either call their demand aggregators (214A, 214B, 214C, respectively) to request bids and/or ad campaign information for available ad inventory or, more likely, use rules configured by their respective demand aggregators to compile and/or determine a set of bids to submit in each auction. A compiled/determined set of bids for a particular ad auction may be empty (that is, contain no qualifying bids) in which case a particular demand-side platform may opt out of participating in that particular ad auction. Each demand-side platform (212A, 212B, 212C) further is configured to submit bids to the real-time bidding platform 218 (e.g., via network 216B) for participation in ad auctions.

Each demand aggregator (included in 214A, 214B, 214C) may be associated with any type of computing device, such as the computing device 100 described with reference to FIG. 1, for example. Generally, each demand aggregator (included in 214A, 214B, 214C) is configured to accept and/or determine bids for available ad inventory and to submit the received bids and/or information from which bids may be determined to an associated demand-side platform. Each demand aggregator may submit multiple bids/information to a demand-side platform for the same ad inventory. In this instance, each submitted bid/information from a demand aggregator is often associated with a different company, ad, ad campaign, brand, or the like.

The real-time bidding platform 218 is configured to determine which demand-side platforms can participate in an auction for each ad inventory opportunity submitted to it by the online content publishers (210A, 10B, 210C). The real-time bidding platform 218 additionally is configured to request bids from each qualifying demand-side platform, receive bids for ad auctions from demand-side platforms (e.g., 212A, 212B, 212C), determine auction winners, and determine clearing prices using configurable clearing price logic parameters set by the online content publishers (210A, 210B, 210C). Still further, in embodiments, the real-time bidding platform 218 is configured to look-up parameter values in the table provided by an online content publisher without any corresponding change in the code

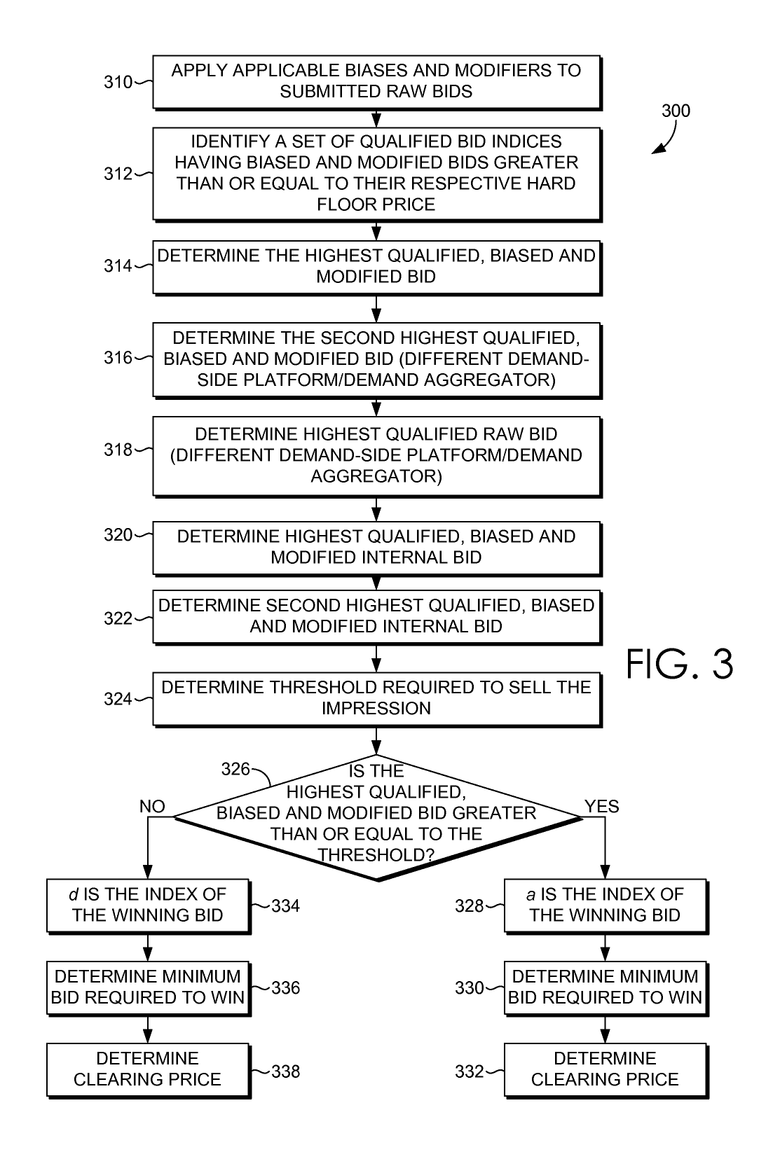

Turning now to FIG. 3, a flow diagram showing an exemplary method 300 for determining a winning demand source for an auction and a clearing price is illustrated. Initially, any applicable biases and modifiers are applied to each of a plurality of submitted raw bids (Rᵢ (indexed by i)) to find the respective biased and modified bids (Tᵢ (indexed by i)). This is indicated at block 310. In embodiments, biased and modified bids (Tᵢ (indexed by i)) may be determined in accordance with the following:

Tᵢ=Rᵢ*(1+Mᵢ+Bᵢ)+Aᵢ+Nᵢ, wherein Mᵢ is the total multiplicative modifier for the bid indexed by i, Bᵢ is the total multiplicative bias for the bid indexed by i, Aᵢ is the total additive bias for the bid indexed by i, and Nᵢ is the total additive modifier or the bid indexed by i.

As indicated at block 312, a set of qualified bid indices (Q) having biased and modified bids (Tᵢ (indexed by i)) equal to or greater than their respective hard floor price (Fᵢ (indexed by i)) is identified. If a biased and modified bid (Tᵢ (indexed by i)) is below its hard floor price Fᵢ (indexed by i), it is not qualified to compete in the auction. In embodiments, the set of qualified bid indices (Q) is determined in accordance with the following:

Q=i:Tᵢ≧Fᵢ}.

As indicated at block 314, the highest qualified, biased and modified bid (Tₐ) is determined. In embodiments, the highest qualified, biased and modified bid (Tₐ) is determined in accordance with the following:

Tₐ=max {Tᵢ:i ε Q}. In embodiments, if there is a tie for Tₐ, the tied biased and modified bid (T) having the highest associated raw bid (R) is selected. If there is still a tie, random selection may be applied.

As indicated at block 316, the second highest qualified, biased and modified bid T_{b} submitted from a different demand-side platform or demand aggregator than the demand-side platform or demand aggregator associated with Tₐ is determined. In embodiments, such may be determined in accordance with the following:

T_{b}=max {Tᵢ: i ε Q and (Demand-Side Platform(i) ≠ Demand-Side Platform(a) or Demand Aggregator(i) ≠ Demand Aggregator(a))}, where Demand-Side Platform(i) is a function that returns the Demand-Side Platform ID for the bid indexed by i, Demand Aggregator(i) is a function that returns the Demand Aggregator ID for the bid indexed by i, Demand-Side Platform(a) is a function that returns the Demand-Side Platform ID for the bid indexed by a, and Demand Aggregator(a) is a function that returns the Demand Aggregator ID for the bid indexed by a. If there is a tie, T_{b} may be selected amongst the tied qualified, biased and modified bids utilizing any method known to those of ordinary skill in the art.

As indicated at block 318, the highest qualified raw bid (Rₑ) from a different demand-side aggregator or demand aggregator than a is determined. In embodiments, such may be determined in accordance with the following:

R_{c}=max {Rᵢ: i ε Q and (Demand-Side Platform(i) ≠ Demand-Side Platform(a) or Demand Aggregator(i) ≠ Demand-Aggregator (a))}. If there is a tie, R_{c} may be selected from amongst the tied qualified raw bids from different demand-side platforms and/or demand aggregators than a utilizing any method known to those of skill in the art.

As indicated at block 320, the highest qualified, biased and modified internal bid (T_{d}) is determined. In embodiments, T_{d} may be determined in accordance with the following:

T_{d}=max {Tᵢ:i ε Q and Internal(i)=true}, where Internal(i) is a function that returns true if the bid indexed by i is from an internal bidder or demand source (demand-side platform/demand aggregator combinations—as determined by the online content publisher having the ad opportunity), false otherwise. In embodiments, Internal(i) may check whether Fᵢ=0. If there is a tie for T_{d}, the tied bid from an internal demand source having the highest associated raw bid (R) may be selected. If there is still a tie, random selection may be applied.

As indicated at block 322, the second highest qualified, biased and modified internal bid (Tₑ) is determined. In embodiments, Tₑ may be determined in accordance with the following:

Tₑ=max {Tᵢ: i ε Q and Internal(i) and i ≠d}. If there is a tie, Tₑ may be selected amongst the tied bids utilizing any method known to those of ordinary skill in the art.

As indicated at block 324, the threshold required to sell the impression (D) is determined. In embodiments, if Internal(a), the threshold may be determined in accordance with the following:

D=max {Fₐ, T_{b}}. In embodiments if a non-Internal(a), the threshold may be determined in accordance with the following:

D=max {Fₐ, T_{b}, C₀+C₁*T_{b}+C₂*T_{d}}, where C₀ represents the spread between the highest and second-highest qualified biased bids that is required to win the auction. For instance, if it is required that the winning bid be $0.05 CPM higher than the second-highest bid, the spread of $0.05 may be captured when there is a winner. In embodiments, C₀ is a decimal value between −5 and 5 with at least five decimal digits of accuracy in CPM units that can be configured at run time based upon one or more of ad sizes, the identity of the pages on which ads are presented, the content of the pages on which ads are presented, targeting segments of which the user or browser ID is a member, or any combination thereof. C₁ and C₂ are multiples of the highest qualified non-winning and internal bids that are used to set the auction price. In embodiments, C₁ is equal to 1 and C₂ is equal to 0. In other embodiments, a higher value for C₂ may be optimal. In embodiments, C₁ and C₂ are non-negative decimal values less than ten with at least five decimal digits of accuracy that are configurable at run time based upon one or more of ad sizes, the identity of the pages on which ads are presented, the content of the pages on which ads are presented, targeting segments of which the user or browser ID is a member, or any combination thereof.

As indicated at block 326, it is next determined if Tₐ is greater than or equal to D. If it is determined that Tₐ is greater than or equal to D, a is the index of the winning bid, as indicated at block 328. If it is determined that Tₐ is not greater than or equal to D, d is the index of the winning bid, as indicated at block 334.

If it is determined at block 326 that a is the index of the winning bid (w), the minimum bid required to win, E, is next determined, as indicated at block 330. In embodiments, the minimum bid required to win, E, when a is the index of the winning bid, may be determined in accordance with the following equation:

E=(D−Aᵢ−Nᵢ)/(1+Mᵢ+Bᵢ). The clearing price, P, is then calculated, as indicated at block 332. In embodiments, the clearing price, P, may be determined in accordance with the following equation:

P=min{R_{w}, C₇+max {C₃*E, C₄*T_{b}, C₅*R_{c}, C₆*Sₐ}}, where Sₐ is the soft floor price of the bid indexed by a. C₃ and C₄ are used to determine whether the highest qualified non-winning biased and raw bids, respectively, are used in the clearing-price calculation. In embodiments, C₃ and C₄ will each be equal to 0 (false) or 1 (true). In embodiments, C₃ and C₄ are non-negative decimal values less than ten with at least five decimal digits of accuracy that are configurable at run time based upon one or more of ad sizes, the identity of the pages on which ads are presented, the content of the pages on which ads are presented, targeting segments of which the user or browser ID is a member, or any combination thereof. C₅ is used to determine whether the highest non-winning raw bid is used in the calculation of the clearing price and will typically have a value equal to 0 or 1. C₆ is used to determine whether the soft floor price is used in the calculation of the clearing price. C₇ represents a bid increment, typically $0.01 CPM that is added to the price computed from the other received bids. C₅ and C₆ are non-negative decimal values less than ten with at least five decimal digits of accuracy that are configurable at run time based upon one or more of ad sizes, the identity of the pages on which ads are presented, the content of the pages on which ads are presented, targeting segments of which the user or browser ID is a member, or any combination thereof. C₇ is a non-negative decimal value less than ten with at least three decimal digits of accuracy in CPM units that is configurable at run time based upon one or more of ad sizes, the identity of the pages on which ads are presented, the content of the pages on which ads are presented, targeting segments of which the user or browser ID is a member, or any combination thereof.

If it is determined at block 326 that d is the index of the winning bid, the minimum bid required to win, E, is next determined, as indicated at block 336. In embodiments, the minimum bid required to win, E, when d is the index of the winning bid may be determined in accordance with the following equation:

E=(D−Aᵢ−Nᵢ)/(1+Mᵢ+Bᵢ). The clearing price, P, is then calculated, as indicated at block 338. In embodiments, the clearing price logic, P, may be determined in accordance with the following equation:

P=min {R_{w}, C₇+max {C₃*E, C₄*Tₑ, C₆*S_{d}}}, where S_{d} is the soft floor price of the bid indexed by d.

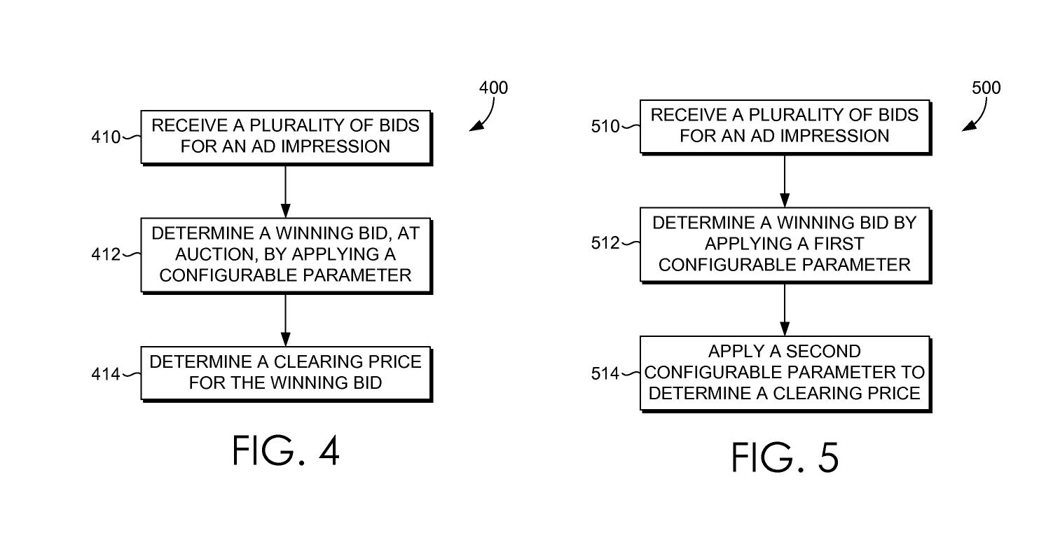

With reference now to FIG. 4, a flow diagram is illustrated showing an exemplary method 400 for determining clearing prices in ad exchanges. As indicated at block 410, a plurality of bids for an ad impression is received. The winning bid is then determined, at auction time, by applying at least one first configurable parameter to at least a portion of the received bids, as indicated at block 412. A clearing price for the winning bid is then determined, as indicated at block 414.

With reference now to FIG. 5, a flow diagram is illustrated showing another exemplary method 500 for determining clearing prices in ad exchanges. As indicated at block 510, a plurality of bids for an ad impression is received. At least one first configurable parameter is then applied to at least a portion of the received bids to determine a winning bid of the plurality of received bids, as indicated at block 512. At least one second configurable parameter is then applied to determine a clearing price for the winning bid, as indicated at block 514.

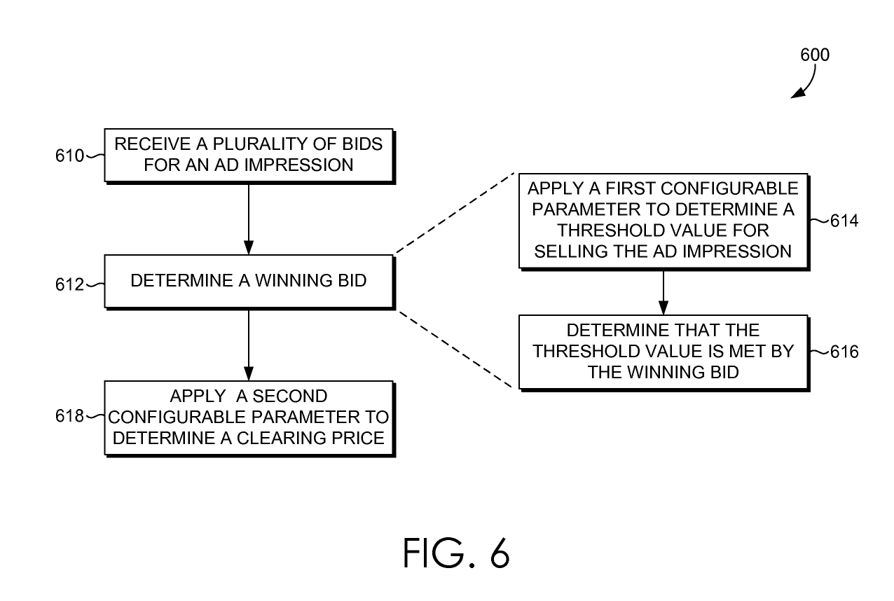

Turning to FIG. 6, a flow diagram is illustrated showing yet another exemplary method 600 for determining clearing prices in ad exchanges. As indicated at block 610, a plurality of bids for an ad impression is received. It is then determined, as indicated at block 612, that there is a winning bid of the plurality of received bids. This determination is made by applying at least one first configurable parameter to the at least a portion of the received bids to determine a threshold value for selling the ad impression, as indicated at block 614, and determining that the threshold value is met by the winning bid, as indicated at block 616. In embodiments, each at least one first configurable parameter is equivalent to a predetermined spread between a highest qualified biased bid and a second-highest qualified biased bid for winning the ad impression, a multiple of a highest qualified biased bid submitted by an internal demand source, or a multiple of a highest qualified non-winning biased bid.

As indicated at block 618, at least one second configurable parameter is applied to determine a clearing price for the winning bid. Each at least one second configurable parameter is utilized to determine whether a highest qualified non-winning biased bid is used in determining the clearing price for the winning bid or to determine whether a highest qualified non-winning raw bid is used in determining the clearing price for the winning bid.

As can be understood, embodiments of the present invention provide systems, methods, and computer-readable storage media for, among other things, altering clearing price logic at auction time. Configurable parameters included in the clearing price logic make the logic configurable at run time based upon one or more of ad sizes, the identity of the pages on which ads are presented, the content of the pages on which ads are presented, targeting segments of which the user or browser ID is a member, or any combination thereof. This enables experimentation in the exchange and optimization of the logic without requiring alterations in the code and ensures that the price paid is at least equivalent to the minimum bid that would have been needed to win the auction. In accordance with embodiments hereof, bids that are below the floor price are not included when computing the clearing price for the winning bid.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIG. 3, 400 of FIG. 4, 500 of FIG. 5, and 600 of FIG. 6 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for determining clearing prices in ad exchanges, the method comprising:
receiving a plurality of bids for an ad impression;
determining that there is a winning bid of the plurality of received bids by applying, at auction time, at least one first configurable parameter to at least a portion of the received bids; and
determining a clearing price for the winning bid.

2. The one or more computer-readable storage media of claim 1, wherein the at least one first configurable parameter is configurable based upon one or more of an ad size, an identity of a page on which the ad impression will be presented, content of the page on which the ad will be presented, a targeting segment of which a user or browser ID is a member, or any combination thereof.

3. The one or more computer-readable storage media of claim 1, wherein determining that there is a winning bid of the plurality of received bids comprises:
applying the at least one first configurable parameter to the at least a portion of the received bids to determine a threshold value for selling the ad impression; and
determining that the threshold value is met by the winning bid.

4. The one or more computer-readable storage media of claim 3, wherein the threshold value for selling the ad impression differs based upon whether the winning bid is associated with an internal demand source or an external demand source.

5. The one or more computer-readable storage media of claim 1, wherein the at least one first configurable parameter is equivalent to a predetermined spread between a highest qualified biased bid and a second-highest qualified biased bid for winning the ad impression.

6. The one or more computer-readable storage media of claim 1, wherein the at least one first configurable parameter is equivalent to a multiple of a highest qualified biased non-winning bid.

7. The one or more computer-readable storage media of claim 1, wherein the at least one first configurable parameter is equivalent to a multiple of a highest qualified biased bid submitted by an internal demand source.

8. The one or more computer-readable storage media of claim 1, wherein determining the clearing price for the winning bid comprises applying at least one second configurable parameter.

9. The one or more computer-readable storage media of claim 8, wherein the at least one second configurable parameter is configurable based upon one or more of an ad size, an identity of a page on which the ad impression will be presented, content of a page on which an ad will be presented, a targeting segment of which a user or browser ID is a member, or any combination thereof.

10. The one or more computer-readable storage media of claim 8, wherein the at least one second configurable parameter is utilized to determine whether a highest qualified non-winning biased bid or a highest qualified non-winning raw bid is used in determining the clearing price for the winning bid.

11. The one or more computer-readable storage media of claim 8, wherein the at least one second configurable parameter is utilized to determine whether a soft floor price is used in determining the clearing price for the winning bid.

12. A method being performed by one or more computing devices including at least one processor, the method for determining clearing prices in ad exchanges, the method comprising:
receiving a plurality of bids for an ad impression;
determining that there is a winning bid of the plurality of received bids by applying at least one first configurable parameter to at least a portion of the received bids; and
applying at least one second configurable parameter to determine a clearing price for the winning bid.

13. The method of claim 12, wherein the at least one first configurable parameter and the at least one second configurable parameter are configurable based upon one or more of an ad size, an identity of a page on which the ad impression will be presented, content of the page on which the ad impression will be presented, a targeting segment of which a user or browser ID is a member, or any combination thereof.

14. The method of claim 12, wherein determining that there is a winning bid of the plurality of received bids comprises:
applying the at least one first configurable parameter to the at least a portion of the received bids to determine a threshold value for selling the ad impression; and
determining that the threshold value is met by the winning bid.

15. The method of claim 14, wherein the threshold value for selling the ad impression differs based upon whether the winning bid is associated with an internal demand source or an external demand source.

16. The method of claim 12, wherein each at least one first configurable parameter is equivalent to a predetermined spread between a highest qualified biased bid and a second-highest qualified biased bid for winning the ad impression, a multiple of a highest qualified biased bid submitted by an internal demand source, or a multiple of a highest qualified non-winning biased bid.

17. The method of claim 12, wherein each at least one second configurable parameter is utilized to determine whether a highest qualified non-winning biased bid is used in determining the clearing price for the winning bid, to determine whether a highest qualified non-winning raw bid is used in determining the clearing price for the winning bid, or to determine whether a soft floor price is used in determining the clearing price for the winning bid.

18. One or more computer-readable storage media storing computer-useable instructions that, when used by one or more computing devices, cause the one or more computing devices to perform a method for determining clearing prices in ad exchanges, the method comprising:
receiving a plurality of bids for an ad impression;
determining that there is a winning bid of the plurality of received bids by:
applying at least one first configurable parameter to at least a portion of the received bids to determine a threshold value for selling the ad impression; and
determining that the threshold value is met by the winning bid,
wherein each at least one first configurable parameter is equivalent to a predetermined spread between a highest qualified biased bid and a second-highest qualified biased bid for winning the ad impression, a multiple of a highest qualified biased bid submitted by an internal demand source, or a multiple of a highest qualified non-winning biased bid; and
applying at least one second configurable parameter to determine a clearing price for the winning bid,
wherein each at least one second configurable parameter is utilized to determine whether a highest qualified non-winning biased bid is used in determining the clearing price for the winning bid, to determine whether a highest qualified non-winning raw bid is used in determining the clearing price for the winning bid, or to determine whether a soft floor price is used in determining the clearing price for the winning bid.

19. The computer-readable storage media of claim 18, wherein the at least one first configurable parameter and the at least one second configurable parameter are configurable based upon one or more of an ad size, an identity of a page on which the ad impression will be presented, content of the page on which the ad impression will be presented, a targeting segment of which a user or browser ID is a member, or any combination thereof.

20. The computer-readable storage media of claim 18, wherein the threshold value for selling the ad impression differs based upon whether the winning bid is associated with an internal demand source or an external demand source.
